(19) United States
(12) Patent Application Publication
(10) Pub. No.: US 2026/0116207 A1
(43) Pub. Date: Apr. 30, 2026

(54) OVERMODULATION USING RECTANGULAR CARRIER-BASED PULSE-WIDTH MODULATION IN ELECTRIFIED VEHICLES

(71) Applicant: FCA US LLC, Auburn Hills, MI (US)

(72) Inventor: Peter Azer, Auburn Hills, MI (US)

(21) Appl. No.: 18/932,931

(22) Filed: Oct. 31, 2024

(51) Int. Cl. B60L 15/02; B60L 15/08; B60L 50/51

(52) U.S. Cl. CPC B60L 15/025; B60L 15/08; B60L 50/51; B60L 2210/42; B60L 2240/423; B60L 2240/48; B60L 2240/527

(57) ABSTRACT

A control system for an electric motor of an electrified vehicle includes an inverter of the electrified vehicle, the inverter comprising a set of switches and being configured to receive three pulse-width modulation (PWM) signals and to control the set of switches to generate an alternating current (AC) output voltage from a direct current (DC) link voltage provided by a battery system of the electrified vehicle, and a control system configured to determine a torque command for the electric motor, determine commanded d-axis and q-axis voltages based on the torque command, generate a rectangular wave modulating signal for carrier-based PWM based on the commanded d-axis and q-axis voltages, generate the three PWM signals by performing carrier-based PWM using the rectangular wave modulating signal, and control the electric motor using the AC output voltage generated by the inverter.

### FIELD

The present application generally relates to electrified vehicles and, more particularly, to overmodulation carrier-based rectangular pulse-width modulation (PWM) in electrified vehicles.

### BACKGROUND

An electrified vehicle includes at least one electric motor configured to generate torque for vehicle propulsion. For a three-phase alternating current (AC) motor (e.g., a permanent magnet motor), direct current (DC) power is provided by a high voltage battery pack or system, which is then converted by an inverter into three phase AC power and used to control three windings of the electric motor. A modulation index of the inverter is defined as a ratio of an output line peak voltage (V_{m_line}) to the DC link voltage (VDC). Space vector modulation (SVM) is one pulse-width modulation (PWM) motor control technique that is capable of achieving a modulation index of 1. By adding overmodulation, a higher modulation index (˜1.103) can be achieved, which can be used to increase motor torque output. SVM, however, is difficult and costly to implement. Accordingly, while such conventional motor control techniques do work for their intended purpose, there exists an opportunity for improvement in the relevant art.

### SUMMARY

According to one example aspect of the invention, a control system for an electric motor of an electrified vehicle is presented. In one exemplary implementation, the control system comprises an inverter of the electrified vehicle, the inverter comprising a set of switches and being configured to receive three pulse-width modulation (PWM) signals and to control the set of switches to generate an alternating current (AC) output voltage from a direct current (DC) link voltage provided by a battery system of the electrified vehicle, and a control system configured to determine a torque command for the electric motor, determine commanded d-axis and q-axis voltages based on the torque command, generate a rectangular wave modulating signal for carrier-based PWM based on the commanded d-axis and q-axis voltages, generate the three PWM signals by performing carrier-based PWM using the rectangular wave modulating signal, and control the electric motor using the AC output voltage generated by the inverter.

In some implementations, the rectangular wave modulating signal is capable of achieving a modulation index for the inverter of greater than one. In some implementations, the control system is further configured to determine a magnitude of the rectangular wave modulating signal by calculating:

$${V}_{m \_ line} = \sqrt{3} \times \sqrt{{v}_{d}^{2} + {v}_{q}^{2}} , \qquad ( 1 )$$

where V_{m_line} represents an output line peak voltage and v_{d} and v_{q} represent the commanded d-axis and q-axis voltages, respectively. In some implementations, the control system is further configured to determine the modulation index for the inverter by calculating:

$${m}_{a} = \frac{{V}_{m \_ line}}{{V}_{DC}} , \qquad ( 2 )$$

where V_{DC} represents the DC link voltage.

In some implementations, the control system is further configured to determine the magnitude of the rectangular wave modulating signal by calculating:

$$A = \frac{{m}_{a}}{{m}_{a , max}} \times \frac{{V}_{DC}}{2} , \qquad ( 3 )$$

where A represents an amplitude of the rectangular wave modulating signal, mₐ represents the modulation index, and m_{a,max} represents a maximum value of the modulation index. In some implementations, the maximum value for the modulation index is approximately 1.103.

In some implementations, the control system is further configured to determine an angle or phase (φ) of the rectangular wave modulating signal by calculating:

$$φ = \frac{π}{2} - \frac{π}{2} sign ( {v}_{d} ) + ( {tan}^{- 1} \vert \frac{{v}_{d}}{{v}_{q}} \vert ) sign ( {v}_{d} \times {v}_{q} ) , \qquad ( 4 )$$

where v_{d} and v_{q} represent the commanded d-axis and q-axis voltages, respectively, and sign determines a sign of a respective variable. In some implementations, the control system is further configured to compare, for each of the three phases, the rectangular wave modulating signal to the carrier signal to determine the respective PWM signal. In some implementations, the carrier signal is a triangular wave signal.

According to another example aspect of the invention, a control method for an electric motor of an electrified vehicle is presented. In one exemplary implementation, the control method comprises providing an inverter of the electrified vehicle, the inverter comprising a set of switches and being configured to receive three PWM signals and to control the set of switches to generate an AC output voltage from a DC link voltage provided by a battery system of the electrified vehicle, determining, by a control system of the electrified vehicle, a torque command for the electric motor, determining, by the control system, commanded d-axis and q-axis voltages based on the torque command, generating, by the control system, a rectangular wave modulating signal for carrier-based PWM based on the commanded d-axis and q-axis voltages, generating, by the control system, the three PWM signals by performing carrier-based PWM using the rectangular wave modulating signal, and controlling, by the control system, the electric motor using the AC output voltage generated by the inverter.

In some implementations, the rectangular wave modulating signal is capable of achieving a modulation index for the inverter of greater than one. In some implementations, the control method further comprises determining, by the control system, a magnitude of the rectangular wave modulating signal by calculating:

$${V}_{m \_ line} = \sqrt{3} \times \sqrt{{v}_{d}^{2} + {v}_{q}^{2}} , \qquad ( 1 )$$

where V_{m_line} represents an output line peak voltage and v_{d} and v_{q} represent the commanded d-axis and q-axis voltages, respectively. In some implementations, the control method further comprises determining, by the control system, the modulation index for the inverter by calculating:

$${m}_{a} = \frac{{V}_{m \_ line}}{{V}_{D C}} , \qquad ( 2 )$$

where V_{DC} represents the DC link voltage.

In some implementations, the control method further comprises determining, by the control system, the magnitude of the rectangular wave modulating signal by calculating:

$$A = \frac{{m}_{a}}{{m}_{a , max}} \times \frac{{V}_{D C}}{2} , \qquad ( 3 )$$

where A represents an amplitude of the rectangular wave modulating signal, mₐ represents the modulation index, and m_{a,max} represents a maximum value of the modulation index. In some implementations, the maximum value for the modulation index is approximately 1.103.

In some implementations, the control method further comprises determining, by the control system, an angle or phase (φ) of the rectangular wave modulating signal by calculating:

$$φ = \frac{π}{2} - \frac{π}{2} sign ( {v}_{d} ) + ( {tan}^{- 1} \vert \frac{{v}_{d}}{{v}_{q}} \vert ) sign ( {v}_{d} \times {v}_{q} ) , \qquad ( 4 )$$

where v_{d} and v_{q} represent the commanded d-axis and q-axis voltages, respectively, and sign determines a sign of a respective variable. In some implementations, the control method further comprises comparing, by the control system and for each of the three phases, the rectangular wave modulating signal to the carrier signal to determine the respective PWM signal. In some implementations, the carrier signal is a triangular wave signal.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a plot of an example carrier-based rectangular pulse-width modulation (PWM) including a rectangular wave modulating signal and a rectangular carrier wave according to the principles of the present application;

FIG. 2 is a functional block diagram of an electrified vehicle having an electric motor and an example control system therefor according to the principles of the present application;

FIGS. 3A-3B are plots of example determinations of the magnitude of the rectangular wave modulating signal according to the principles of the present application;

FIG. 4 is a plot of an example determination of the phase of the rectangular wave modulating signal according to the principles of the present application;

FIG. 5 is a functional block diagram of an example system architecture for the control system according to the principles of the present application; and

FIG. 6 is a flow diagram of an example control method for an electric motor of an electrified vehicle according to the principles of the present application.

### DESCRIPTION

As previously discussed, space vector modulation (SVM) is one pulse-width modulation (PWM) motor control technique that is capable of achieving a modulation index of 1. By adding overmodulation, a higher modulation index (˜1.103) can be achieved, which can be used to increase motor torque output. SVM, however, is difficult and costly to implement. More specifically, SVM involves commanding one of six different inverter states. In contrast to SVM, carrier-based sinusoidal PWM is much simpler and less costly. This technique involves using a carrier signal (e.g., a triangular wave) and a modulating signal (e.g., the desired alternating current, or AC output voltage) to control the switching (on/off states) of switches/transistors of the inverter to ensure that the output voltage of the inverter follows a desired waveform (e.g., a sinusoid). Conventional carrier-based sinusoidal PWM techniques, however, are limited to a lesser modulation index (˜0.866). One overmodulation technique for carrier-based sinusoidal PWM techniques is harmonic injection, but this only increases the modulation index to 1.

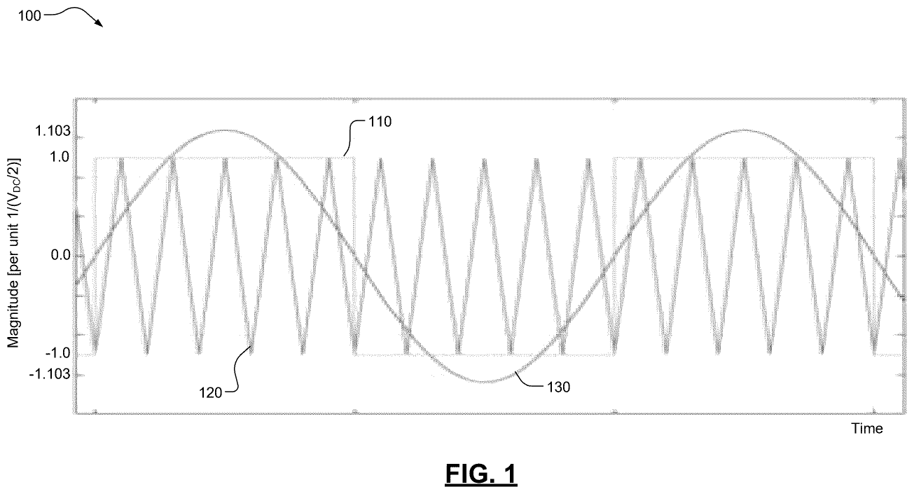

Accordingly, a carrier-based rectangular PWM technique is presented herein. As explained more fully herein, this carrier-based rectangular PWM technique is capable of achieving the higher modulation index (˜1.103) achievable by SVM with overmodulation. As shown in the plot 100 of FIG. 1, the carrier-based rectangular PWM has a rectangular wave modulating signal 110 with a triangular carrier wave 120, which results in a fundamental component 130 of the phase voltage having the desired peak magnitude (˜1.103). A frequency of the rectangular wave modulating signal 110 corresponds to the inverter fundamental frequency and a frequency of the carrier wave 120 corresponds to the inverter switching frequency. The magnitude/phase of the rectangular wave modulating signal 110 are determined from the commanded direct and quadrature (dq) voltages. In application, the carrier-based rectangular PWM technique is utilized to generate the PWM signals for controlling three legs of an inverter for generating the three AC phase voltages for the respective windings of an electric motor of an electrified vehicle.

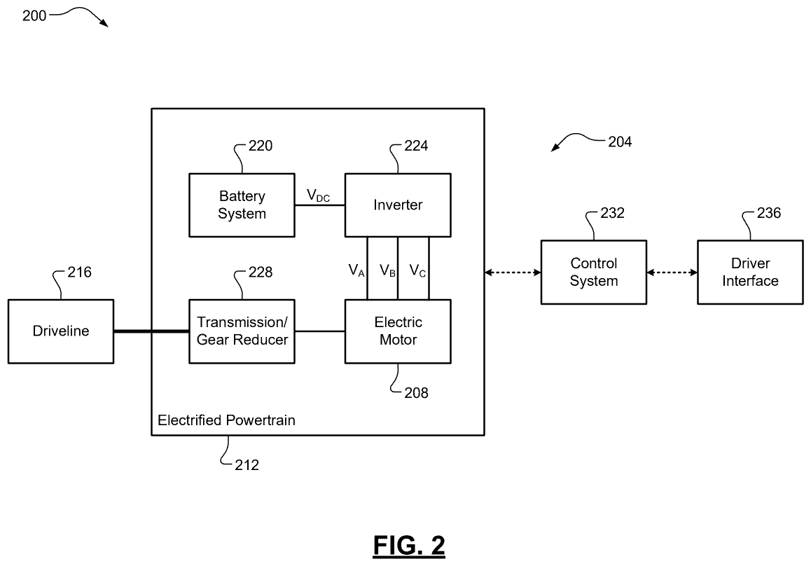

Referring now to FIG. 2, a functional block diagram of an electrified vehicle 200 including an electric motor 208 and an example control system 204 therefor according to the principles of the present application is illustrated. The electrified vehicle 200 comprises an electrified powertrain 212 that is configured to generate and transfer drive torque to a driveline 216 for propulsion. As shown, the electrified powertrain 212 comprises the electric motor 208, a high voltage battery pack or system 220, an inverter 224, and a transmission or gear reducer 228. While one electric motor 208 and inverter 224 are shown, it will be appreciated that the electrified powertrain 208 could include multiple electric motors/inverters, as well as other optional components, such as a secondary power source (an internal combustion engine, a fuel cell system, etc.). In one exemplary implementation, the electric motor 208 is a three-phase AC motor (e.g., a permanent magnet motor) that is powered by three phase voltages V_{A}, V_{B}, V_{C} generated by the inverter 224. The inverter 224 (e.g., a full-bridge rectifier) comprises three switching bridges or legs that are configured to generate these three phase voltages V_{A}, V_{B}, V_{C} (e.g., collectively forming one AC voltage waveform) from a DC link voltage (V_{DC}) output by the battery system 220.

The optional transmission or gear reducer 228 is configured to transfer (e.g., multiply) the drive torque from the electric motor 208 to a final drive ratio at the driveline 216. The electrified vehicle 200 is controlled by a controller or control system 232. The control system 232, for example, could include a plurality of electronic control units (ECUs) connected to each other via a controller area network (CAN). For example only, the control system 232 could include a supervisory controller, such as an electrified vehicle control unit (EVCU) or hybrid control processor (HCP), and secondary controllers, such as a motor control processor (MCP) and a battery pack control module (BPCM). One primary function of the control system 232 is to control the electrified powertrain 208 to generate a desired amount of drive torque to satisfy a driver torque request, which could be provided via a driver of the electrified vehicle 200 via a driver interface 236 (e.g., an accelerator pedal). While not explicitly shown, it will be appreciated that the electrified vehicle 200 could further include other sensors/actuators.

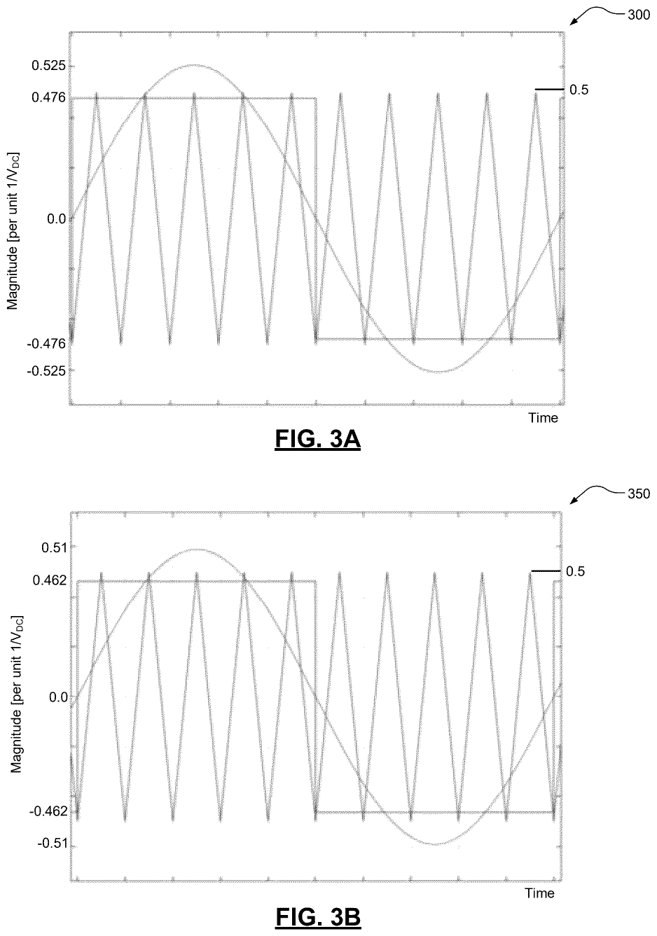

Referring now to FIGS. 3A-3B and with continued reference to the previous figures, plots 300, 350 of two example determinations of the magnitude of the rectangular wave modulating signal according to the principles of the present application are illustrated. For a given dq command (d-axis voltage v_{d} and q-axis voltage v_{q}), a peak line voltage (V_{m_line}) is calculated, then a modulation index (mₐ) is calculated, and then a magnitude or amplitude (A) for the rectangular wave modulating signal is calculated. For example, these calculations could be as follows:

$${V}_{m \_ line} = \sqrt{3} \times \sqrt{{v}_{d}^{2} + {v}_{q}^{2}} , \qquad ( 1 )$$

$${m}_{a} = \frac{{V}_{m \_ line}}{{V}_{D C}} , and \qquad ( 2 )$$

$$A = \frac{{m}_{a}}{{m}_{a , max}} \times \frac{{V}_{D C}}{2} , \qquad ( 3 )$$

where m_{a,max} is a maximum value for the modulation index mₐ (e.g., 1.103). In the example determination of FIG. 3A, the modulation index mₐ is calculated to be 1.05 and the amplitude A is calculated to be ˜(0.476×V_{DC}). Similarly, in the example determination of FIG. 3B, the modulation index mₐ is calculated to be 1.02 and the amplitude A is calculated to be ˜(0.462×V_{DC}).

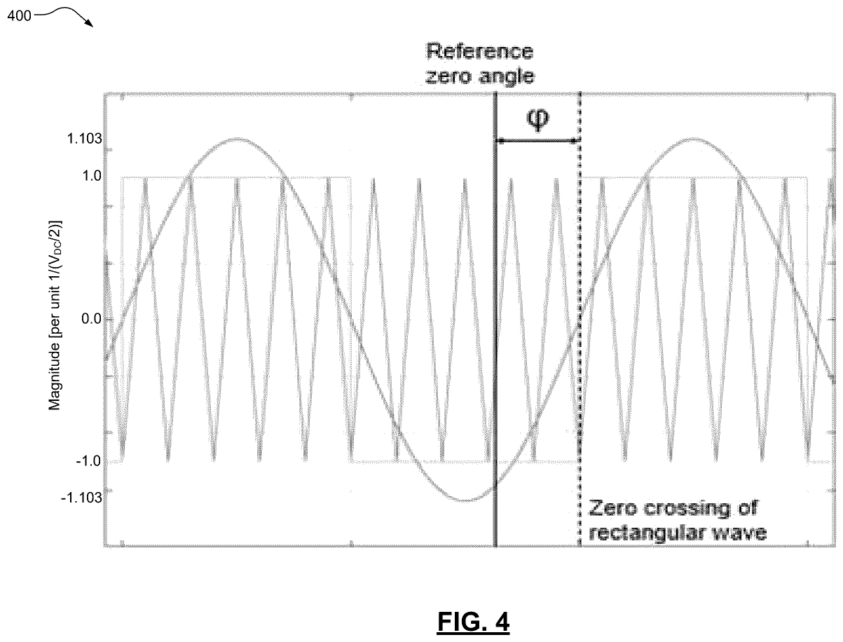

Referring now to FIG. 4 and with continued reference to the previous figures, a plot 400 of an example determination of the phase of the rectangular wave modulating 410 according to the principles of the present application is illustrated. As shown, the modulation index is m_{a,max} or 1.103. The positive zero-crossing of the rectangular wave modulating signal 410 and the fundamental phase voltage component are the same. Thus, by controlling the angle (φ) of the rectangular wave modulating signal 410, the angle of the fundamental phase voltage is controlled:

$$φ = \frac{π}{2} - \frac{π}{2} sign ( {v}_{d} ) + ( {tan}^{- 1} \vert \frac{{v}_{d}}{{v}_{q}} \vert ) sign ( {v}_{d} \times {v}_{q} ) , \qquad ( 4 )$$

where sign determines the sign of the variable. Thus, the phase or angle φ of the rectangular wave modulating signal 410 can be determined (based on the dq command, or v_{d} and v_{q}) using the above-described equation/relationship. FIG. 4 shows an example of the maximum modulating index where the peak line voltage equals 1.103×V_{DC}. This is equivalent to the six-step operation of SVM.

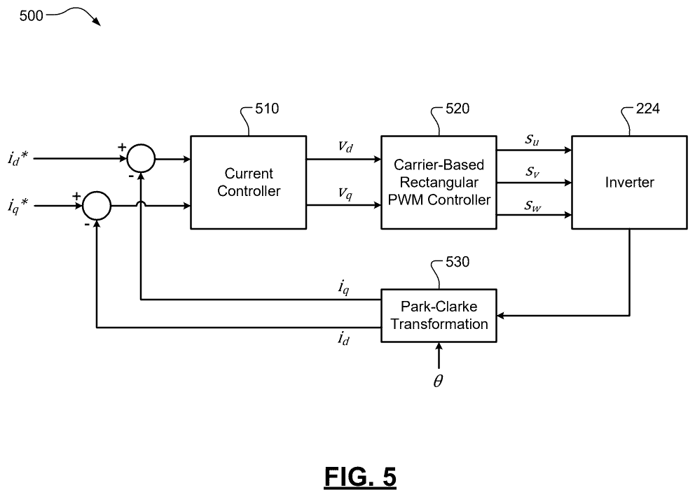

Referring now to FIG. 5 and with continued reference to the previous figures, a functional block diagram of an example system architecture 500 for the control system 132 according to the principles of the present application is illustrated. A current controller 510 receives a dq current command (commanded d-axis current i_{d}* and commanded q-axis current i_{q}*) corresponding to a driver torque request for the electric motor 208. Based on these values and feedback (i_{d} and i_{q}) determines the dq voltage command (the d-axis voltage v_{d} and the q-axis voltage v_{q}) and outputs these values to a carrier-based rectangular PWM controller 520. This block 520 generates PWM signals (sᵤ, sᵥ, and s_{w}) based on the commanded d-axis voltage v_{d} and the q-axis voltage v_{q} and outputs these values to the inverter 224. The steps or calculations performed by block 520 include those previously-described herein, including calculating a desired magnitude or amplitude A of the rectangular wave modulating signal by calculating a desired modulation index mₐ based on a ratio of the desired output line peak voltage (V_{m_line}) to the DC link voltage V_{DC} and thereafter calculating the magnitude or amplitude A based on these other parameters (e.g., using Equations 1-3).

The steps of calculations performed by block 520 also include determining the desired angle (φ) for the rectangular wave modulating signal as previously-described herein (e.g., using Equation 4). Finally, block 520 generates the PWM signals sᵤ, sᵥ, s_{w} for phases u, v, and w by comparing each phase's rectangular wave modulating signal to the carrier signal and, when the modulating signal is greater than the carrier signal, the respective PWM signal is one, and otherwise (i.e., when the modulating signal is less than the carrier signal), the respective PWM signal is zero. The inverter 224 uses these PWM signals sᵤ, sᵥ, s_{w} to control its switches/transistors such that it outputs a desired AC voltage (e.g., a sinusoid) having a desired modulation index mₐ for achieving the desired motor torque. The phase currents iᵤ, iᵥ, and i_{w} (collectively, i_{uvw}) are returned as feedback and converted back to the dq domain by a Park-Clarke transformation 530 (based further on an instantaneous angle θ if an arbitrary φ frequency) to provide the feedback d-axis and q-axis currents i_{d} and i_{q}, respectively, which are compared (i.e., subtract) from the commanded d-axis and q-axis currents i_{d}* and i_{q}*, respectively, and then used to determine the dq voltage command.

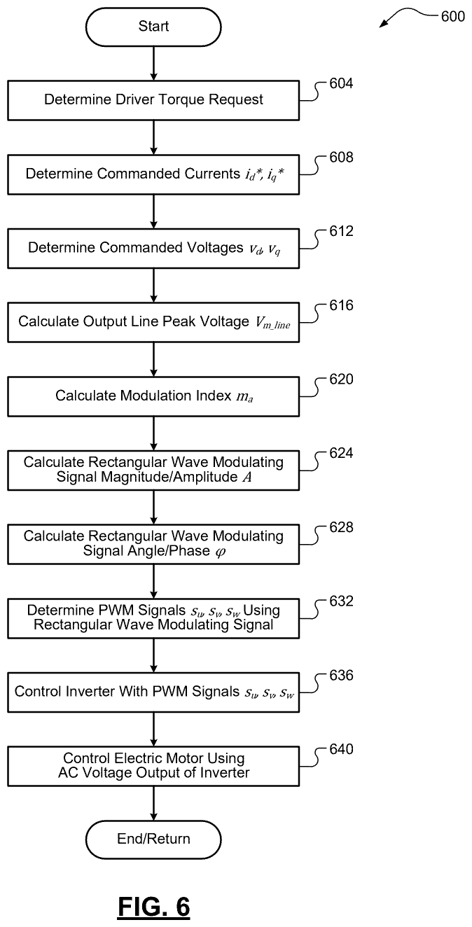

Referring now to FIG. 6, a flow diagram of an example control method 600 for an electric motor of an electrified vehicle according to the principles of the present application is illustrated. While the method 600 specifically references the electrified vehicle 100 and its components, it will be appreciated that the method 600 could be applicable to other suitably configured electrified vehicles, as well as non-vehicle power conversion applications. The method 600 begins at 604 where the control system 132 receives a driver torque request via the driver interface 136. At 608, the control system 132 determines a dq current command (i_{d}* and i_{q}*) based on the driver torque request and other parameters of the electrified powertrain 212. At 612, the control system 132 determines a dq voltage command (v_{d} and v_{d}) based on the dq current command and current feedback (i_{d} and i_{q}). 6t 816, the control system 132 determines a desired output line peak voltage V_{m_line} based on the d-axis and q-axis voltages v_{d} and v_{q}, respectively. At 620, the control system 132 determines the desired modulation index mₐ as a ratio of the desired output line peak voltage V_{m_line} to the DC link voltage V_{DC}.

At 624, the control system 132 determines the desired magnitude or amplitude A for the rectangular wave modulating signal as previously discussed herein (e.g., using Equation 3). At 628, the control system 132 determines the desired phase φ for the rectangular wave modulating signal based on the d-axis and q-axis voltages v_{d} and v_{q}, respectively (e.g., using Equation 4). At 632, the control system 132 determines the three PWM phase signals sᵤ, sᵥ, and s_{w} based on a comparison between the respective phase rectangular wave modulating signals and the carrier signal. At 636, the control system 132 controls the inverter 224 using the three PWM phase signals sᵤ, sᵥ, and s_{w} to achieve the desired AC output voltage (e.g., a sinusoid), which is then used to control the electric motor 208 at 640 to achieve the torque request. The method 600 then ends or returns to 604 for one or more additional cycles.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A control system for an electric motor of an electrified vehicle, the control system comprising:
an inverter of the electrified vehicle, the inverter comprising a set of switches and being configured to receive three pulse-width modulation (PWM) signals and to control the set of switches to generate an alternating current (AC) output voltage from a direct current (DC) link voltage provided by a battery system of the electrified vehicle; and
a control system configured to:
determine a torque command for the electric motor;
determine commanded d-axis and q-axis voltages based on the torque command;
generate a rectangular wave modulating signal for carrier-based PWM based on the commanded d-axis and q-axis voltages;
generate the three PWM signals by performing carrier-based PWM using the rectangular wave modulating signal; and
control the electric motor using the AC output voltage generated by the inverter.

2. The control system of claim 1, wherein the rectangular wave modulating signal is capable of achieving a modulation index for the inverter of greater than one.

3. The control system of claim 2, wherein the control system is further configured to determine a magnitude of the rectangular wave modulating signal by calculating:
$${V}_{m \_ line} = \sqrt{3} \times \sqrt{{v}_{d}^{2} + {v}_{q}^{2}} , \qquad ( 1 )$$
where V_{m_line} represents an output line peak voltage and v_{d} and v_{q} represent the commanded d-axis and q-axis voltages, respectively.

4. The control system of claim 3, wherein the control system is further configured to determine the modulation index for the inverter by calculating:
$${m}_{a} = \frac{{V}_{m \_ line}}{{V}_{D C}} , \qquad ( 2 )$$
where V_{DC} represents the DC link voltage.

5. The control system of claim 4, wherein the control system is further configured to determine the magnitude of the rectangular wave modulating signal by calculating:
$$A = \frac{{m}_{a}}{{m}_{a , max}} \times \frac{{V}_{D C}}{2} , \qquad ( 3 )$$
where A represents an amplitude of the rectangular wave modulating signal, mₐ represents the modulation index, and m_{a,max} represents a maximum value of the modulation index.

6. The control system of claim 5, wherein the maximum value for the modulation index is approximately 1.103.

7. The control system of claim 2, wherein the control system is further configured to determine an angle or phase (φ) of the rectangular wave modulating signal by calculating:
$$φ = \frac{π}{2} - \frac{π}{2} sign ( {v}_{d} ) + ( {tan}^{- 1} \vert \frac{{v}_{d}}{{v}_{q}} \vert ) sign ( {v}_{d} \times {v}_{q} ) , \qquad ( 4 )$$
where v_{d} and v_{q} represent the commanded d-axis and q-axis voltages, respectively, and sign determines a sign of a respective variable.

8. The control system of claim 2, wherein the control system is further configured to compare, for each of the three phases, the rectangular wave modulating signal to the carrier signal to determine the respective PWM signal.

9. The control system of claim 8, wherein the carrier signal is a triangular wave signal.

10. A control method for an electric motor of an electrified vehicle, the control method comprising:
providing an inverter of the electrified vehicle, the inverter comprising a set of switches and being configured to receive three pulse-width modulation (PWM) signals and to control the set of switches to generate an alternating current (AC) output voltage from a direct current (DC) link voltage provided by a battery system of the electrified vehicle;
determining, by a control system of the electrified vehicle, a torque command for the electric motor;
determining, by the control system, commanded d-axis and q-axis voltages based on the torque command;
generating, by the control system, a rectangular wave modulating signal for carrier-based PWM based on the commanded d-axis and q-axis voltages;
generating, by the control system, the three PWM signals by performing carrier-based PWM using the rectangular wave modulating signal; and
controlling, by the control system, the electric motor using the AC output voltage generated by the inverter.

11. The control method of claim 10, wherein the rectangular wave modulating signal is capable of achieving a modulation index for the inverter of greater than one.

12. The control method of claim 11, further comprising determining, by the control system, a magnitude of the rectangular wave modulating signal by calculating:
$${V}_{m \_ line} = \sqrt{3} \times \sqrt{{v}_{d}^{2} + {v}_{q}^{2}} , \qquad ( 1 )$$
where V_{m_line} represents an output line peak voltage and v_{d} and v_{q} represent the commanded d-axis and q-axis voltages, respectively.

13. The control method of claim 12, further comprising determining, by the control system, the modulation index for the inverter by calculating:
$${m}_{a} = \frac{{V}_{m \_ line}}{{V}_{D C}} , \qquad ( 2 )$$
where V_{DC} represents the DC link voltage.

14. The control method of claim 13, further comprising determining, by the control system, the magnitude of the rectangular wave modulating signal by calculating:
$$A = \frac{{m}_{a}}{{m}_{a , max}} \times \frac{{V}_{D C}}{2} , \qquad ( 3 )$$
where A represents an amplitude of the rectangular wave modulating signal, mₐ represents the modulation index, and m_{a,max} represents a maximum value of the modulation index.

15. The control method of claim 14, wherein the maximum value for the modulation index is approximately 1.103.

16. The control method of claim 11, further comprising determining, by the control system, an angle or phase (φ) of the rectangular wave modulating signal by calculating:
$$φ = \frac{π}{2} - \frac{π}{2} sign ( {v}_{d} ) + ( {tan}^{- 1} \vert \frac{{v}_{d}}{{v}_{q}} \vert ) sign ( {v}_{d} \times {v}_{q} ) , \qquad ( 4 )$$
where v_{d} and v_{q} represent the commanded d-axis and q-axis voltages, respectively, and sign determines a sign of a respective variable.

17. The control method of claim 11, further comprising comparing, by the control system and for each of the three phases, the rectangular wave modulating signal to the carrier signal to determine the respective PWM signal.

18. The control method of claim 17, wherein the carrier signal is a triangular wave signal.
